(19) United States
(12) Patent Application Publication
(10) Pub. No.: US 2005/0084807 A1
(43) Pub. Date: Apr. 21, 2005

(54) Reducing photoresist line edge roughness using chemically-assisted reflow

(76) Inventors: Robert P. Meagley, Hillsboro, OR (US); Michael D. Goodner, Hillsboro, OR (US); E. Steve Putna, Beaverton, OR (US); Shan C. Clark, Forest Grove, OR (US); Wang Yueh, Portland, OR (US)

Correspondence Address: TROP PRUNER & HU, PC, 8554 KATY FREEWAY, SUITE 100, HOUSTON, TX, 77024, US

(21) Appl. No.: 10/688,521

(22) Filed: Oct. 17, 2003

(51) Int. Cl. G03C 5/18

(52) U.S. Cl. 430/464

(57) ABSTRACT

Line edge roughness may be reduced by treating a patterned photoresist with a plasticizer. The plasticizer may be utilized in a way to surface treat the photoresist after development. Thereafter, the plasticized photoresist may be subjected to a heating step to reflow the photoresist. The reflow process may reduce the line edge roughness of the patterned, developed photoresist.

### BACKGROUND

This invention relates generally to semiconductor processing and, particularly, to the formation of photoresists.

In patterning semiconductor wafers to form integrated circuits, photoresists are used. Photoresists are materials whose etchability may be altered by selectively exposing them to radiation. Photoresist, after exposure, is either harder or easier to remove by a development process. Thus, a pattern on a mask may be transferred to the semiconductor wafer by selectively exposing the photoresist. That pattern, once transferred to the photoresist, may then be subsequently utilized to form structures in the semiconductor wafer in a repeatable fashion using an etch process.

Advances in photolithography have enabled increasingly smaller patterns to be transferred to semiconductor wafers. This means that increasingly smaller integrated circuits may be formed at lower cost. However, photolithographic processes are subject to so-called line edge roughness. Line edge roughness is surface roughness in the patterned photoresist features.

While resolution has improved, the line edge roughness has not improved correspondingly. As a result of line edge roughness, for example, transistors may experience leakage. Line edge roughness becomes more of a problem as the patterns transferred become increasingly smaller.

Thus, there is a need for better ways to reduce line edge roughness in photolithographic processes.

### BRIEF DESCRIPTION OF THE DRAWINGS

FIG. 1 is an enlarged, cross-sectional, schematic view of an early stage in accordance with one embodiment of the present invention;

FIG. 2 is an enlarged, cross-sectional, schematic view of the embodiment shown in FIG. 1 after further processing in accordance with one embodiment of the present invention;

FIG. 3 is an enlarged, cross-sectional, schematic view of the embodiment shown in FIG. 2 after further processing in accordance with one embodiment of the present invention; and

FIG. 4 is an enlarged, cross-sectional, schematic view of the embodiment shown in FIG. 3 after further processing in accordance with one embodiment of the present invention.

### DETAILED DESCRIPTION

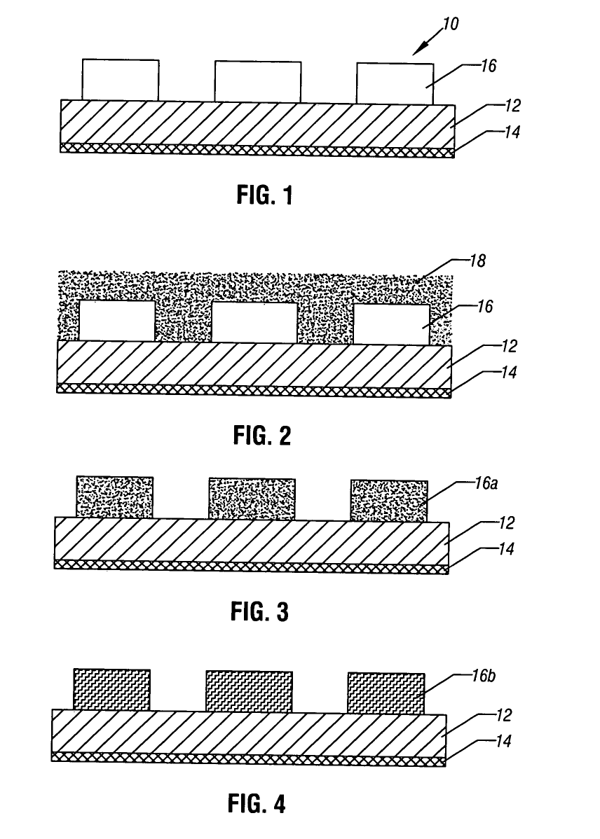

Referring to FIG. 1, a substrate 14 may be covered with layers of material 12 to form a structure 10. It may be desirable to etch patterns in the material 12. To this end, a photoresist mask 16 may be formed on the material 12. Thus, the photoresist mask 16 may be applied and patterned using standard lithographic techniques. The substrate 14 may, for example, be a semiconductor wafer such as a silicon wafer.

Conventionally, photolithographic processes involve a series of well-established steps. Initially the photoresist is spun-on to the semiconductor wafer in a solvent laden state. The solvent is utilized to make the photoresist castable. Once the photoresist has been deposited as a layer on the semiconductor wafer, it may be subjected to a step called soft bake or post-coat bake to drive off excess solvent. Thereafter, the photoresist may be exposed so that regions within the photoresist that are not exposed are either easier or harder to remove. After exposure, a post-exposure bake may be utilized. One or more of the steps just described may result in line edge roughness, which is effectively roughness or irregularities in the features of the photoresist mask 16. After post-exposure bake, the structure 10 may be taken to a developer module. In the developer module, the pattern may be developed or fixed and the resulting structure may be rinsed.

Referring next to FIG. 2, during or after development, the structure 10 may be exposed to a plasticizer. The plasticizer treats the surface regions of the mask 16 to make them more susceptible to reflow. Since line edge roughness arises from surface irregularities, treating the surface regions of the photoresist mask 16 may be effective in reducing line edge roughness. Through the use of the plasticizer 18, relatively low amounts of heat may be utilized to reflow the photoresist mask 16 to remove surface roughness. Without limitation, it is intended that the treatment may cause a surface effect that may result in less than a few nanometers of reflow.

For example, in one embodiment of the present invention, after leaving the developer module, the structure 10 may go to a temperature controlled chamber, for example a prime oven. In the chamber, the structure 10 may be heated. In one embodiment, the structure 10 may be introduced to the vapor phase of a solvent. The time, temperature, pressure, and the amount and type of solvent may be tailored to achieve the desired amount of infusion or diffusion into the photoresist mask 16 to form the doped photoresist mask 16a, shown in FIG. 3.

Thereafter, the structure 10 may be baked to reflow the photoresist mask 16a, reducing surface irregularities. The baking may be sufficient to simply raise a portion of the structure 10 above the glass transition temperature of the mask 16a. The bake may be done under vacuum and in the presence of heat, in some embodiments, to cause reflow particularly targeted at surface irregularities. In some embodiments, the provision of heat and/or vacuum may remove the solvent and control the reflow process and prevent damage of the photoresist mask 16a.

In some embodiments of the present invention, a very controlled reflow does not substantially change the bulk or overall configuration of the photoresist mask 16a. As a result of reflow, the photoresist mask 16b, shown in FIG. 4, may have reduced line edge roughness. In effect, the plasticizer-induced reflow results in smoothing of the surface features of the photoresist mask 16b.

In some embodiments of the present invention, the photoresist mask 16 may be subjected to a separate step involving treatment with volatile or non-volatile plasticizers, following either the develop module or the rinse step of the develop module. The plasticizer may be a liquid, gas, combined gas and liquid phases, or super-critical and liquid gases, including supercritical carbon dioxide, liquid carbon dioxide, or ethane.

Alternatively, the photoresist mask 16 may be exposed to a volatile or non-volatile plasticizer during an existing photoresist development step, such as the post-development wafer rinse. For example, the plasticizer may be added to the developer utilized in the develop module. As another example, the plasticizer may be added to or included in the liquid used for the post-develop rinse.

In each case, the plasticizer is diffused into the surface of the photoresist mask 16. The plasticizer diffusion may be controlled by tailoring the time, temperature, pressure, concentration, and/or carriers utilized to convey the plasticizer into the surface of the photoresist mask 16. The ensuing reflow may be controlled and terminated by a variety of techniques including volatilization of the plasticizer or cooling of the structure 10 to stop the reflow.

Polymer films used to form photoresists can absorb molecules from the environment. Such absorbed species may be tailored to alter the reflow properties of the resist, improving line edge roughness. A plasticizer can lower the glass transition temperature of the photoresist mask 16, allowing rough resist lines to flow and level to reduce overall line edge roughness. The molecules to be absorbed may be introduced into the photoresist in a gas phase, a liquid phase, a combination of gas or liquid, or in a supercritical fluid. A solvent absorbed into the photoresist may act as a plasticizer.

Generally reflow of resists at elevated temperatures is hindered due to the degradation of protecting groups. Plasticizers lower the reflow temperature of the resist. Thus, resists that are prone to chemical degradation may be treated to improve line edge roughness without significantly impacting resist composition or profile.

Examples of plasticizers include carbon dioxide, ethane, propane, butane, chloromethane, hydrofluorocarbons, hydrochlorofluorocarbons, fluorocarbons, or sulfur dioxide gas including vapor phases of solvents. The plasticizer may be a solvent, such as ethyl lactate, or propylene glycol monomethyl ether acetate (in liquid, vapor, or gas phase). The plasticizer may also be a reactive molecule such as styrenic, acrylic, vinyl, AA, or AB condensation monomers. An oligomer or polymer may be utilized as the plasticizer, as well, including a polyol, an olefin, a wax, a steroid, an alkaloid, or a fatty acid.

As another example, hydrofluoroethers may be especially advantageous with hydrophobic photoresists, such as 157 nanometer photoresist. Hydrofluoroethers may be soluble in carbon dioxide gas or supercritical carbon dioxide. Hydrofluoroethers may be effective plasticizers for 157 nanometer photoresists that are fluorine based. The hydrofluoroether molecules may be absorbed as a liquid or a gas into the 157 nanometer resists.

A molecule such as a solvent, steroid, or oligomer can be directly applied to the resist, or dispersed homogeneously in a separate medium and applied to the resist. The addition of cosolvents into the developer or rinse can decrease line edge roughness by dissolving out the partially swollen polymer at the edge of the exposure field. Additionally, a solvent may be applied directly to the resist through liquid dispense, vapor priming, or absorption of solvent vapor. Molecules with plasticization properties have an effect on a resist that can be suspended or stabilized in the continuous phase through conventional processes including solubility differences, surfactants, and the like. In this manner, solvents that are insoluble in the continuous phase can be directed to the resist substrate without impacting the polarity of the continuous phase or the action of the developer.

Use of compressible gases allows the introduction of plasticizers that may not be compatible with mainstream semiconductor processing schemes. Two distinct phases may be achieved with a two-component system where the continuous phase is liquid or supercritical gas. An example is addition of a solvent to a supercritical carbon dioxide, where the concentration of the plasticizer at the prescribed temperature and pressure does not allow the entire mole fraction of the solvent to be successfully and homogeneously distributed within the continuous phase.

In some cases, the plasticizer may be different or the same as the solvent utilized to cast the photoresist film. In addition, the plasticizer may be one that is more or less aggressive than the solvent utilized to cast the photoresist film.

In some embodiments, a plasticizer may be chosen that subsequently provides improved etch resistance. Examples of such material include materials that may polymerize or crosslink the photoresist, therefore making it more chemically resistant to etching thereafter. For example, vinyl and unsaturated derivatives such as divinylbenzene and hexane diol dimethacrylate may be utilized as a liquid phase treatment for positive tone 157 nanometer fluoropolymer-based photoresist patterns.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
developing a patterned photoresist;
applying a plasticizer to the surface of said patterned photoresist to decrease line edge roughness; and
reflowing the photoresist after applying the plasticizer.

2. The method of claim 1 including applying the plasticizer in a supercritical fluid.

3. The method of claim 2 including applying the plasticizer in a supercritical carbon dioxide fluid.

4. The method of claim 1 including applying the plasticizer as a separate step after developing the photoresist.

5. The method of claim 1 including applying the plasticizer with the developer.

6. The method of claim 1 including applying the plasticizer with the develop rinse.

7. The method of claim 1 including applying a plasticizer that improves the etch resistance of the photoresist.

8. The method of claim 1 wherein applying a plasticizer includes diffusing a plasticizer into the photoresist.

9. The method of claim 8 including diffusing a plasticizer in a vapor phase into the photoresist.

10. The method of claim 1 including controlling the amount of reflow by volatilizing the plasticizer during reflow.

11. The method of claim 1 including applying the plasticizer in liquid carbon dioxide.

12. The method of claim 1 including controlling the amount of reflow by cooling the photoresist.

13. A semiconductor structure comprising:
a patterned photoresist; and
a coating of plasticizer on said photoresist.

14. The structure of claim 13 wherein said photoresist is developed.

15. The structure of claim 13 wherein said plasticizer includes hydrofluoroether.

16. A method comprising:
applying a plasticizer to the surface of patterned photoresists to decrease line edge roughness; and
heating the photoresist and the applied plasticizer to reflow the photoresist.

17. The method of claim 16 including applying the plasticizer in a supercritical fluid.

18. The method of claim 17 including applying the plasticizer in a supercritical carbon dioxide fluid.

19. The method of claim 16 including applying the plasticizer as a separate step after developing the photoresist.

20. The method of claim 16 including applying the plasticizer with the developer.

21. The method of claim 16 including applying the plasticizer with the develop rinse.

22. The method of claim 16 including applying a plasticizer that improves the etch resistance of the photoresist.

23. The method of claim 16 wherein applying a plasticizer includes diffusing a plasticizer into the photoresist.

24. The method of claim 16 including controlling the amount of reflow by volatilizing the plasticizer during reflow.

25. The method of claim 16 including controlling the amount of reflow by cooling the photoresist.

26. The method of claim 16 including diffusing a plasticizer in a vapor phase into the photoresist.

27. The method of claim 16 including applying the plasticizer in liquid carbon dioxide.
